(19) United States
(12) Patent Application Publication
(10) Pub. No.: US 2005/0039309 A1
(43) Pub. Date: Feb. 24, 2005

(54) Safety chain assembly having grooved retention mechanism

(76) Inventors: John J. McCauley, Winona, MN (US); Randolph R. Hyde, Winona, MN (US)

Correspondence Address: MOORE, HANSEN & SUMNER, PLLP, 225 SOUTH SIXTH ST, MINNEAPOLIS, MN, 55402, US

(21) Appl. No.: 10/901,255

(22) Filed: Jul. 27, 2004

Related U.S. Application Data
(60) Provisional application No. 60/490,677, filed on Jul. 29, 2003.

(51) Int. Cl. A44B 1/04; B60F 1/00; A44B 15/00; A44B 11/25

(52) U.S. Cl. 24/299

(57) ABSTRACT

A safety chain assembly 24 for securing a towed agricultural vehicle (not shown) to a towing vehicle 21. The safety chain assembly 24 includes a clevis hook 54 having two pin receiving openings 55; a latch member 60 having an attachment opening 62; a spring pin assembly 56, and an elongated load bearing device 36 having a securing opening 37. In the preferred embodiment shown in the drawings the elongated load bearing device 36 is a chain, but it will be appreciated that it could also be a wire rope or other load bearing device having a securing opening 37. Similarly, the preferred spring pin assembly 56 includes a biasing mechanism such as a spring 64 and a washer 66; a retention member 70 and a pin 72; the pin 72 having an annular groove 84, a head 85 and first and second ends 87, 89; the annular groove 84 being located proximate the first end 87 and the head 85 being located proximate the second end 89. The elongated load bearing device 36, preferably the chain 36, and the latch member 60 are interconnected to the clevis hook 54 by the spring pin assembly 56; The retention member is preferably selected from the group consisting of a spring washer and a snap ring and is preferably a snap ring. Methods of attaching and securing the safety chain assembly are also disclosed.

### RELATED INVENTIONS

The present application claims priority to pending U.S. Provisional Patent Application Ser. No. 60/490,677 for SAFETY CHAIN ASSEMBLY HAVING GROOVED RETENTION MECHANISM filed Jul. 29, 2003.

### FIELD OF THE INVENTION

The present invention relates generally to a safety chain assembly for fastening a towing vehicle, such as a tractor or automobile, to a towed vehicle such as a farm implement or trailer. The invention meets the regulations set forth by The American Society of Agricultural Engineers and the American National Standards Institute concerning the use of such chain assemblies.

### BACKGROUND OF THE INVENTION

Safety chain assemblies are used in many applications including securing an implement to a tractor or a trailer to an automobile. The purpose of these assemblies is to prevent separation of the towed and towing vehicles in the event of disengagement of the primary attachment means.

The assemblies are typically comprised of chain links that are connected to a clevis hook by a clevis pin. In standard use, the chain is fixed to the towed vehicle, fed through a loop on the towing vehicle and the clevis hook is then attached to a chain link. Usually, the clevis pin employs a latch to lock the clevis hook to a specific chain link, thus securing the towed and towing vehicles. The latch is believed necessary to ensure that the connection between the clevis hook and the chain link is maintained in the event of excessive vibration or jostling.

One problem associated with these latches is that they can be time-consuming and expensive to manufacture. The components themselves are costly and often require a significant amount of assembly time by a technician.

### SUMMARY OF THE INVENTION

An important aspect of the present invention is to provide a safety chain assembly that securably attaches a towing vehicle, such as a tractor or automobile, to a towed vehicle such as a farm implement or trailer. The safety chain assembly includes a clevis hook, a latch, an elongated load bearing device such as a chain, and a spring pin assembly. The spring pin assembly includes a spring, a washer, a retention mechanism and a pin having a head, a shoulder, an annular groove and a tapered end.

The purpose of the latch in the assembly is to maintain the connection between the clevis hook and the specific chain link to which it is connected. Without the latch, the clevis hook could become disconnected from the chain due to vibration or jostling. This safety chain assembly must be able to maintain the connection between the towed and towing vehicles should the primary means of attachment fail.

The present invention provides an assembly that is more economical and easier to manufacture than the current designs. A spring surrounding the clevis pin is held in place with a washer and retention mechanism. In its preferred embodiment, the retention mechanism is a retaining ring, often called a snap ring, a C-ring or a Circlip. In yet another embodiment, the retention mechanism is an internal tooth retaining ring or spring washer.

These and other objectives and advantages of the invention will appear more fully from the following description, made in conjunction with the accompanying drawings wherein like reference characters refer to the same or similar parts throughout the several views.

### BRIEF DESCRIPTION OF THE DRAWINGS

FIG. 1 is a perspective view of an attachment system for towing a towed agricultural vehicle (not shown); including a secondary attachment mechanism that enables a towing vehicle (shown partially in phantom) to remain connected to the towed vehicle should the primary attachment mechanism (shown partially in phantom) fail; the preferred secondary attachment mechanism includes a safety chain assembly of the present invention, including a clevis hook and latch assembly secured to a safety chain;

FIG. 2 is an enlarged perspective view of a preferred clevis hook and latch assembly of the present invention illustrating a clevis hook (shown in phantom) when secured to a specific chain link (shown in phantom) by a latch member secured to the clevis hook by a spring pin assembly;

FIG. 3 is an enlarged perspective view shown generally from the opposite side of the clevis hook and latch assembly illustrated in FIG. 2, again showing a clevis hook when secured to a specific chain link by a latch member;

FIG. 4 is an exploded view of the clevis hook and latch assembly of the present invention showing the clevis hook, latch, and spring pin assembly of FIGS. 2-3; but showing the clevis hook and a portion of the safety chain in phantom and showing a preferred and an alternate retaining device;

FIG. 5 is a side view of the clevis hook and latch assembly, as seen in FIGS. 2 and 3, showing a sectional view of the latch member in a closed position;

FIG. 6 is a side view similar to that shown in FIG. 5, but showing the latch member in an open position;

FIG. 7 is an enlarged partial sectional view of a portion of the spring pin assembly shown in an encircled portion (7-7) of FIG. 5, but showing a cross-sectional view of the retention member, washer and spring of the assembly; and

FIG. 8 is an exploded view of a prior art clevis hook and latch assembly shown in a manner similar to that shown in FIG. 4, showing a portion of the hook and safety chain in phantom.

### DETAILED DESCRIPTION

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

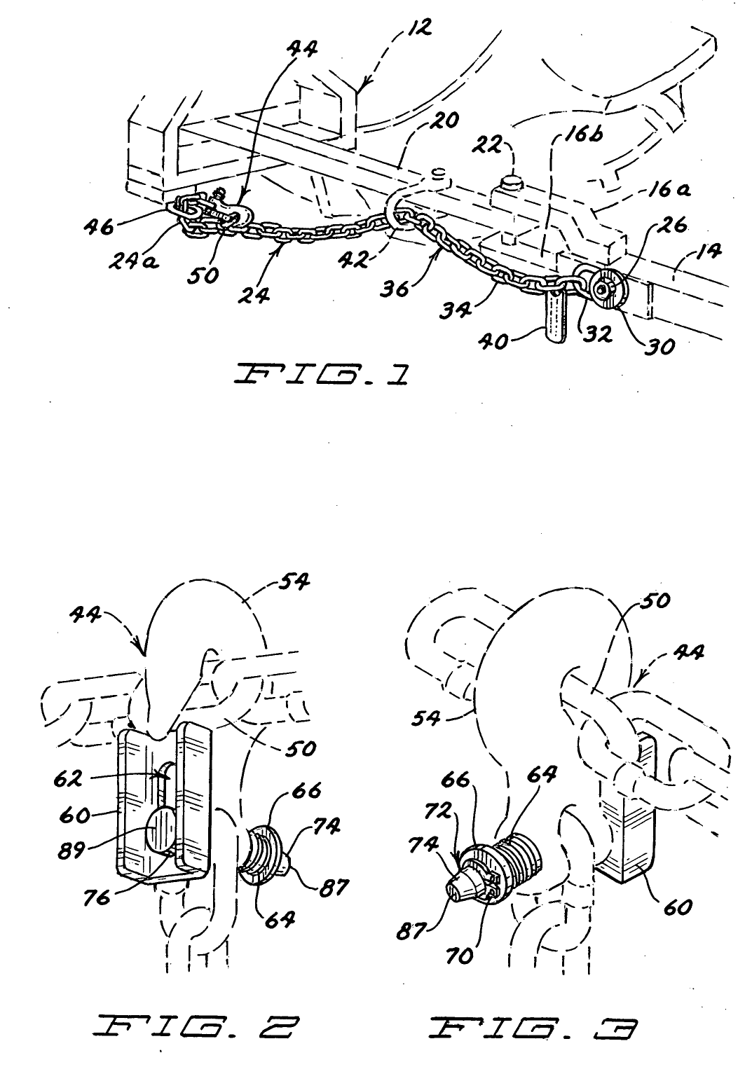

FIG. 1 shows a towing attachment system 10 connecting a towing vehicle 12 (shown in part in phantom) and a towed vehicle (not shown) drawn by a tongue 14. In this embodiment, the tongue 14 of the towed vehicle is split into two furcations 16a and 16b. A draw bar 20, secured to the towing vehicle 12, is interconnected to the tongue 14 of the towed vehicle by a hitch pin 22, thus forming a primary attachment mechanism 23.

Referring now also to FIGS. 2-7, a safety chain assembly 24 of the present invention is shown. The safety chain assembly 24 is used to secure towed agricultural vehicles (not shown) to towing vehicles 12. The safety chain assembly 24 includes a clevis hook 54 having two pin receiving openings 55; a latch member 60 having an attachment opening 62; a spring pin assembly 56, and an elongated load bearing device 36 having a securing opening 37. In preferred embodiments, the elongated load bearing device 36 is a chain 36, but it will be appreciated that it could also be a wire rope or other load bearing device having a securing opening 37. The spring pin assembly 56 includes a spring 64, a washer 66, a retention member 70 and a pin 72; the pin 72 having an annular groove 84, a head 76 and first and second ends 87, 89; the annular groove 84 being located proximate the first end 87 and the head 85 being located proximate the second end 89. It will be appreciated that any other biasing mechanism, in addition to the spring 64, is also contemplated within and may be used within the present invention, so long as it is constructed and arranged so that it urges the first end 87 of the pin 72 away from the securing opening 37 of the clevis hook 54 and urges the head 76 of the pin 72 toward the securing opening 37 of the clevis hook 54. In preferred embodiments, the pin 72 also includes a shoulder 80 immediately adjacent to a bottom surface 81 of the head 76. The elongated load bearing device 36 and the latch member 60 are interconnected to the clevis hook 54 by the spring pin assembly 56. The pin 72 passes through the attachment opening 62, the two pin receiving openings 55 and the securing opening 37 to secure the elongated load bearing device 36 and the latch member 60 to the clevis hook 54, and the retention member 70 is secured within at least a portion of the annular groove 84 to retain the washer 66 and the spring 64 on the pin 72. The retention member 70 is preferably selected from the group consisting of a snap ring 70a and a spring washer 70b, preferably a snap ring 70a.

The safety chain assembly 24 is connected between the towing vehicle 12 and the towed vehicle (not shown) and serves as a secondary means of attachment should the primary attachment mechanism 23 fail. In the preferred embodiment, the safety chain assembly 24 is fixed to the towed vehicle by a bolt 26 and a washer 30 at an enlarged link 32. From the enlarged link 32, individual chain loops or links 34 are interconnected to form a chain 36. A certification tag 40 is connected to an elongated load bearing device, preferably a chain 36 as required by ASAE standards. The chain 36 is fed through a draw bar loop 42 located on the draw bar 20 to prevent the safety chain assembly 24 from dragging on the ground (not shown). At the unfixed end 24a of the safety chain assembly 24, a clevis hook and latch assembly 44 is fed through a towing vehicle loop 46 mounted on the towing vehicle 12. The safety chain assembly 24 is then doubled back on itself and the clevis hook and latch assembly 44 is connected to a single chain link 50 of the chain 36 to achieve the desired length of the safety chain assembly 24.

In FIGS. 2, 3 and 5, the latch member 60 is shown in a closed position, thus securely interconnecting the clevis hook 54 and the chain 36 and in FIG. 6, the latch member 60 is shown in an open position. The attachment opening 62 of the latch member 60 has an upper portion 63, preferably a slot shaped opening, and a lower portion 65 (shown in FIG. 4), preferably a circular shaped portion similar to the cross-sectional shape of the preferred shoulder 80 on the pin 72, but slightly larger in its outer dimension. The upper portion 63 and lower portion 65 allow the clevis hook and latch assembly 44 to be in a closed position as shown in FIGS. 2, 3 and 5 or an open position as shown in FIG. 6.

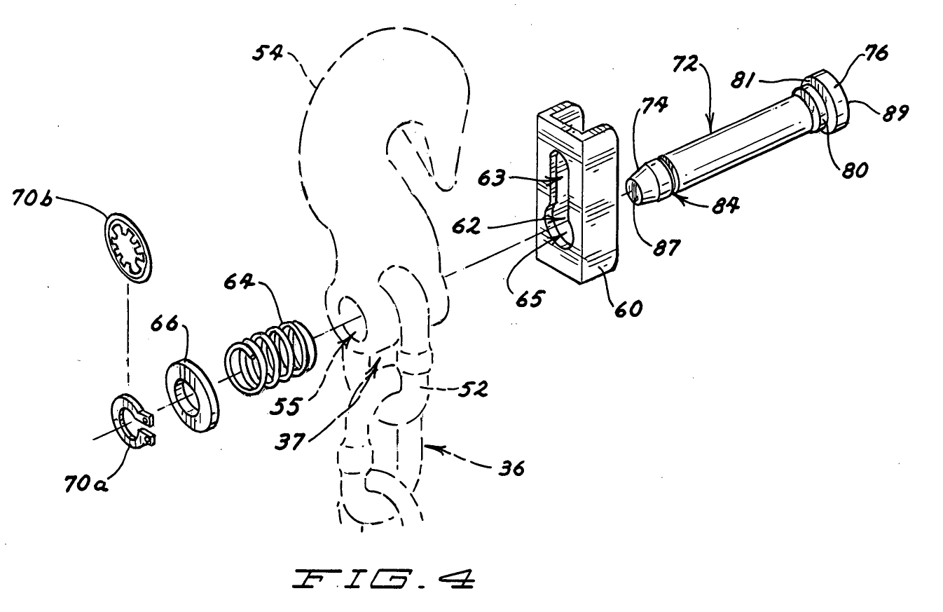

FIG. 3 provides detail of the opposite side of the clevis hook and latch assembly 56 shown in FIG. 2. The clevis hook 54 is connected to the end chain link 52 by the spring pin assembly 56. A spring 64 provides tension for the spring pin assembly 56 and is held in place by a washer 66 and a retention member 70. A pin 72 of the spring pin assembly 56 has a generally tapered end 74 to receive and easily place the retention mechanism 70.

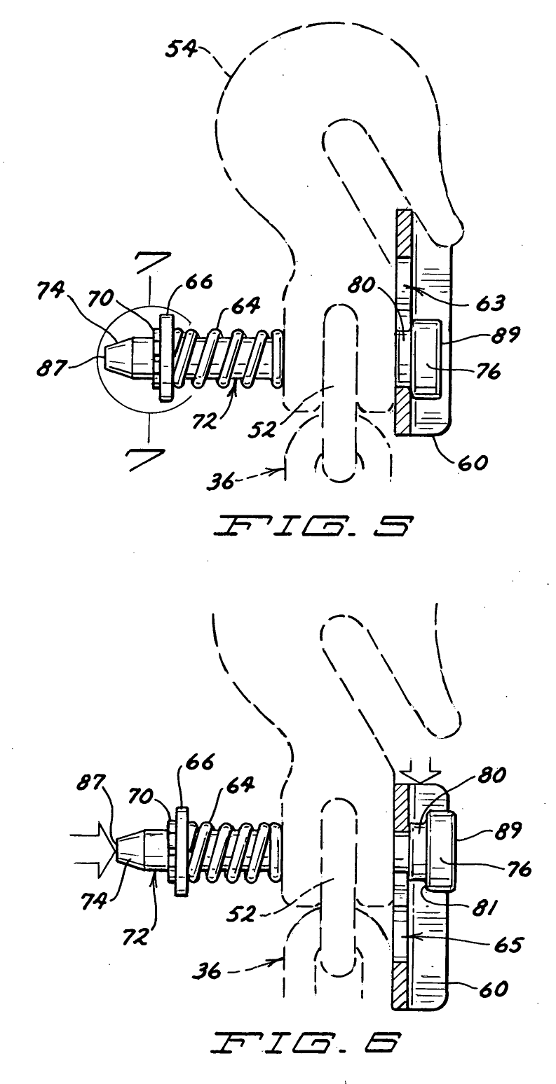

An exploded view of the clevis hook and latch assembly 44 is shown in FIG. 4. The spring 64 provides tension to the spring pin assembly 24 and biases the latch member 60 against the clevis hook 54. The washer 66 is used to hold the spring 64 in place. The retention member 70 shown in FIG. 5 is a retaining ring or snap ring 70a, similar to that shown in FIGS. 2 and 3. In alternate embodiments, an internal tooth retaining ring or spring washer 70b, as shown alternately in FIG. 4, can also be used. The alternate retention member 70b is secured to the pin by pressing the alternate retaining ring 70b over the tapered end 74 of the pin 72 and into the annular groove 84. The preferred retention member 70a is preferably a snap ring 70a that is forced into the annular groove 84 from the side of the pin 72.

The clevis hook and latch assembly 44 is shown as a sectional side view in FIG. 5. The clevis hook 54, end chain link 52 and chain 36 are shown in phantom. The latch member 60 is shown in the closed position. The shoulder 80 of the pin 72 is position within in the lower portion 65 thus locking the latch member 60 in the closed position. The pin 72 is also attaching the end chain link 52 to the clevis hook 54. The spring 64 surrounds the pin 72 biases the latch member 60 against the clevis hook 54. The spring 64 is secured between the clevis hook 54 and the washer 66 by the retention member 70, ensuring that the shoulder 80 remains within the lower portion 65 unless force is exerted against first end 87 of the pin 72 to compress the spring 64, thereby allowing the shoulder 80 to be displaced from the lower portion 65 of the attachment opening 62.

The latch member 60 of the safety chain assembly 24 has a latched position shown in FIGS. 2, 3 and 5 and an unlatched position shown in FIG. 6. The spring 64 is compressed between the clevis hook 54 and the washer 66, such that the shoulder 80 is biased against the latch member 60 when the latch member 60 is in the unlatched position and the shoulder 80 is immediately adjacent to the upper portion 63 and the bottom surface 81 of the head is biased against the latch member 60 when the latch member 60 is in the latched position and the shoulder 80 resides within the lower portion 65; wherein the spring 64 can be compressed by exerting force against the tapered end 74 of the pin 72 proximate the annular groove 84 when the latch member 60 is in the latched position, such that the shoulder 80 is displaced sufficiently from the lower portion 65 to permit the latch member 60 to be displaced so that the shoulder 80 is adjacent to the upper portion 63 of the attachment opening 62, which has at least one dimension that is smaller than at least one dimension of the shoulder 80.

FIG. 6 shows a side view of the clevis hook and latch assembly 44. By pressing on the tapered end 74 of the pin 72, the spring 64 is compressed and allows the pin shoulder 80 to be removed from the lower portion 82. This displacement permits the latch member 60 to be displaced so that the pin shoulder 80 is adjacent to the upper portion 63 of the attachment opening 62. The latch member 60 is thus in an open position, permitting the clevis hook 54 to receive a chain link 50.

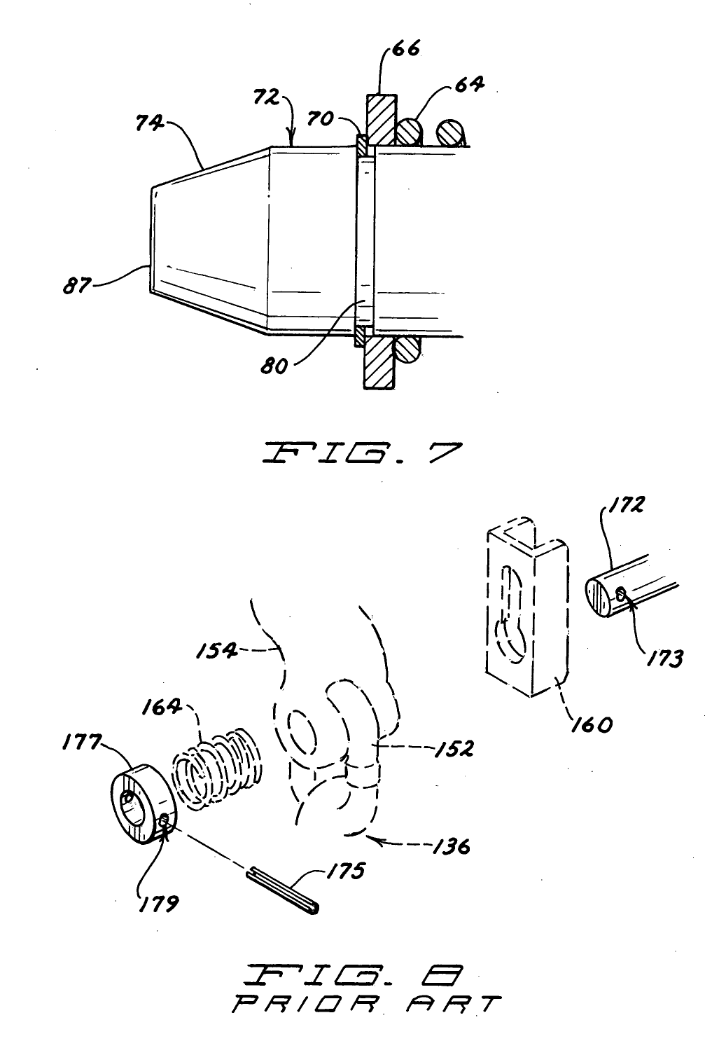

FIG. 7 shows a partial sectional view of the encircled portion (7-7) of FIG. 5. The spring 64 is held in place by a washer 66 and retention member 70. The retention member 70 is placed in the annular groove 84 by being pressed over the tapered end 74 of the pin 72 into the annular groove 84.

A prior art clevis hook and latch assembly 144 is shown in FIG. 8. A partially shown clevis hook 154, latch member 160, end chain link 152 and chain 136 are shown in phantom. A spring 164 is held on a pin 172 by a collar 179 that is secured to the pin 172 by a roll pin 175 which is pressed through a receiving opening 179 in the collar 177 and a securing opening 173 in the pin 172. A cotter pin (not shown) can be used in the place of the roll pin 175.

A method of attaching a latch member 60 and an elongated load bearing device 36 to a safety hook 54 is also provided; the method includes the steps of providing a spring pin assembly 56; and securing the elongated load bearing device 36 and the latch member 60 to the clevis hook 54 by the spring pin assembly 56; wherein the pin 72 passes through the attachment opening 62, the two pin receiving openings 55 and the securing opening 37 to secure the elongated load bearing device 36 and the latch member 60 to the clevis hook 54, and the retention member 70 is secured within at least a portion of the annular groove 84 to retain the washer 66 and the spring 64 on the pin 72.

The latch member 60 has a latched position and an unlatched position; the spring 64 being compressed between the clevis hook 54 and the washer 66 such that shoulder 80 is biased against the latch member 60 when the latch member 60 is in the unlatched position and the shoulder 80 in immediately adjacent to the upper portion 63 and the bottom surface 81 of the head 76 is biased against the latch member 60 when the latch member 60 is in the latched position and the shoulder 80 resides within the lower portion 65; wherein the spring 64 can be compressed by exerting force against the tapered end 74 of the pin 72 proximate the annular groove 84 when the latch member 60 is in the latched position such that the shoulder 80 is displaced sufficiently from the lower portion 65 to permit the latch member 60 to be displaced so that the shoulder 80 is adjacent to the upper portion 63 of the attachment opening 62, which has at least one dimension that is smaller than at least one dimension of the shoulder 80. The present invention further includes a method including a step of placing the latch member 60 in the latched position including:
a) exerting a force on the end of the pin proximate the annular groove such that the spring is further compressed when the latch member is in the unlatched position and such that the latch member can be displaced from the unlatched position, in which the shoulder is immediately adjacent the upper portion of the attachment opening, to an intermediate position in which the shoulder is immediately adjacent the lower portion of the attachment opening;
b) exerting a force on the latch member to displace the latch member from the unlatched position, in which the shoulder is immediately adjacent the upper portion of the attachment opening, to an intermediate position in which the shoulder is immediately adjacent the lower portion of the attachment opening;
c) permitting the biasing force of the spring to displace the shoulder into the lower opening to secure the latch member in the latched position.

The method further comprises a step of placing the latch member in the unlatched position including:
a) exerting a force on the end of the pin proximate the annular groove such that the spring is further compressed when the latch member is in the latched position and such that the latch member can be displaced from the latched position, in which the shoulder is immediately adjacent the upper portion of the attachment opening, to an intermediate position in which the shoulder is immediately adjacent the lower portion of the attachment opening;
b) exerting a force on the latch member to displace the latch member from the latched position to the unlatched position in which the shoulder is immediately adjacent the upper portion of the attachment opening.

The invention described above may be embodied in other forms without departing from the spirit or essential characteristics thereof. The embodiments disclosed in this application are to be considered in all respects as illustrative and not restrictive. The scope of the invention is indicated by the appended claims rather than by the foregoing description and all changes which come within the meaning and range of equivalency of the claims are intended to be embraced therein.

1. A safety chain assembly, the safety chain assembly comprising:
a clevis hook having two pin receiving openings;
a latch member having an attachment opening;
a spring pin assembly, the spring pin assembly including a biasing mechanism, a retention member and a pin; the pin having an annular groove, a head and first and second ends; the annular groove being located proximate the first end and the head being located proximate the second end; and
an elongated load bearing device having a securing opening, the elongated load bearing device and the latch member being interconnected to the clevis hook by the spring pin assembly; wherein the pin passes through the attachment opening, the two pin receiving openings and the securing opening to secure the elongated load bearing device and the latch member to the clevis hook, and the retention member is secured within at least a portion of the annular groove to retain the washer and the spring on the pin.

2. The safety chain assembly according to claim 1, wherein the retention member is selected from the group consisting of a spring washer and a snap ring.

3. The safety chain assembly according to claim 2, wherein said retention member is a spring washer attached to the pin to retain the biasing mechanism on the pin.

4. The safety chain assembly according to claim 2, wherein said retention member is a snap ring attached to the pin to retain the biasing mechanism on the pin.

5. The safety chain assembly according to claim 1, wherein the end of the pin proximate the annular groove is tapered.

6. The safety chain assembly according to claim 1, wherein the elongated load bearing device is a chain having a plurality of links, the plurality of links including a first link, the securing opening being located in the first link, the chain and the latch member being interconnected to the clevis hook by the spring pin assembly; wherein the pin passes through the attachment opening, the two pin receiving openings and the securing opening to secure the elongated load bearing device and the latch member to the clevis hook.

7. The safety chain assembly according to claim 1, wherein the attachment opening has an upper portion and a lower portion and the pin has a shoulder adjacent to a bottom surface of the head, the shoulder having a cross-sectional, two-dimensional, shape through a thickness of the shoulder perpendicular to a longitudinal axis of the pin and the lower portion of the attachment opening having a shape similar to, but slightly enlarged in comparison to, the cross-sectional shape of the shoulder such that the shoulder can reside within the lower portion.

8. The safety chain assembly according to claim 7, wherein the latch member has a latched position and an unlatched position; the biasing mechanism being a spring that is compressed between the clevis hook and a washer secured on the pin by the retention member such that the shoulder is biased against the latch member when the latch member is in the unlatched position and the shoulder is immediately adjacent to the upper portion and the bottom surface of the head is biased against the latch member when the latch member is in the latched position and the shoulder resides within the lower portion; wherein the biasing mechanism can be compressed by exerting force against the end of the pin proximate the annular groove when the latch member is in the latched position such that the shoulder is displaced sufficiently from the lower portion to permit the latch member to be displaced so that the shoulder is adjacent to the upper portion of the attachment opening which has at least one dimension that is smaller than at least one dimension of the shoulder.

9. A method of attaching a latch member and an elongated load bearing device to a safety hook, the latch member having an attachment opening, the safety hook being a clevis hook having two pin receiving openings and the elongated load bearing device having a securing opening, the method comprising the steps of:
1) providing a spring pin assembly, the spring pin assembly including a biasing mechanism, a retention member and a pin; the pin having an annular groove, a head and first and second ends; the annular groove being located proximate the first end and the head being located proximate the second end; and
2) securing the elongated load bearing device and the latch member being interconnected to the clevis hook by the spring pin assembly; wherein the pin passes through the attachment opening, the two pin receiving openings and the securing opening to secure the elongated load bearing device and the latch member to the clevis hook, and the retention member is secured within at least a portion of the annular groove to retain the biasing mechanism on the pin.

10. The method of claim 9, wherein the elongated load bearing device is a chain having a plurality of links, the plurality of links including a first link, the securing opening being located in the first link, and wherein the step of securing includes securing the chain and the latch member to the clevis hook by the spring pin assembly; wherein the pin passes through the attachment opening, the two pin receiving openings and the securing opening to secure the chain and the latch member to the clevis hook.

11. The method of claim 9, wherein the retention member is selected from the group consisting of a spring washer and a snap ring and the step of securing includes securing the retention member within at least a portion of the annular groove to retain the biasing mechanism on the pin.

12. The method of claim 9, wherein the attachment opening has an upper portion and a lower portion and the pin has a shoulder adjacent to a bottom surface of the head, the shoulder having a cross-sectional, two-dimensional, shape through a thickness of the shoulder perpendicular to a longitudinal axis of the pin and the lower portion of the attachment opening having a shape similar to, but slightly enlarged in comparison to, the cross-sectional shape of the shoulder such that the shoulder can reside within the lower portion; wherein the latch member has a latched position and an unlatched position; the biasing mechanism being compressed between the clevis hook and the retention member such that shoulder is biased against the latch member when the latch member is in the unlatched position and the shoulder in immediately adjacent to the upper portion and the bottom surface of the head is biased against the latch member when the latch member is in the latched position and the shoulder resides within the lower portion; wherein the biasing mechanism can be compressed by exerting force against the end of the pin proximate the annular groove when the latch member is in the latched position such that the shoulder is displaced sufficiently from the lower portion to permit the latch member to be displaced so that the shoulder is adjacent to the upper portion of the attachment opening that has at least one dimension that is smaller than at least one dimension of the shoulder; wherein the method further comprises a step of placing the latch member in the latched position, including:
a) exerting a force on the end of the pin proximate the annular groove such that the spring is further compressed when the latch member is in the unlatched position and such that the latch member can be displaced from the unlatched position, in which the shoulder is immediately adjacent the upper portion of the attachment opening, to an intermediate position in which the shoulder is immediately adjacent the lower portion of the attachment opening;
b) exerting a force on the latch member to displace the latch member from the unlatched position, in which the shoulder is immediately adjacent the upper portion of the attachment opening, to an intermediate position in which the shoulder is immediately adjacent the lower portion of the attachment opening;
c) permitting the biasing force of the biasing mechanism to displace the shoulder into the lower opening to secure the latch member in the latched position.

13. The method of claim 12, wherein the method further comprises a step of placing the latch member in the unlatched position including:
a) exerting a force on the end of the pin proximate the annular groove such that the biasing mechanism is further compressed when the latch member is in the latched position and such that the latch member can be displaced from the latched position, in which the shoulder is immediately adjacent the upper portion of the attachment opening, to an intermediate position in which the shoulder is immediately adjacent the lower portion of the attachment opening;
b) exerting a force on the latch member to displace the latch member from the latched position to the unlatched position in which the shoulder is immediately adjacent the upper portion of the attachment opening.

14. A safety chain assembly, the safety chain assembly comprising:
a clevis hook having two pin receiving openings;
a latch member having an attachment opening;
a spring pin assembly, the spring pin assembly including a spring, a washer, a retention member and a pin; the pin having an annular groove, a head and first and second ends; the annular groove being located proximate the first end and the head being located proximate the second end; and
an elongated load bearing device having a securing opening, the elongated load bearing device and the latch member being interconnected to the clevis hook by the spring pin assembly; wherein the pin passes through the attachment opening, the two pin receiving openings and the securing opening to secure the elongated load bearing device and the latch member to the clevis hook, and the retention member is secured within at least a portion of the annular groove to retain the washer and the spring on the pin.

15. The safety chain assembly according to claim 14, wherein the retention member is selected from the group consisting of a spring washer and a snap ring.

16. The safety chain assembly according to claim 15, wherein said retention member is a spring washer attached to the pin to retain the washer and the spring on the pin.

17. The safety chain assembly according to claim 15, wherein said retention member is a snap ring attached to the pin to retain the washer and the spring on the pin.

18. The safety chain assembly according to claim 14, wherein the end of the pin proximate the annular groove is tapered.

19. The safety chain assembly according to claim 14, wherein the elongated load bearing device is a chain having a plurality of links, the plurality of links including a first link, the securing opening being located in the first link, the chain and the latch member being interconnected to the clevis hook by the spring pin assembly; wherein the pin passes through the attachment opening, the two pin receiving openings and the securing opening to secure the elongated load bearing device and the latch member to the clevis hook.

20. The safety chain assembly according to claim 14, wherein the attachment opening has an upper portion and a lower portion and the pin has a shoulder adjacent to a bottom surface of the head, the shoulder having a cross-sectional, two-dimensional, shape through a thickness of the shoulder perpendicular to a longitudinal axis of the pin and the lower portion of the attachment opening having a shape similar to, but slightly enlarged in comparison to, the cross-sectional shape of the shoulder such that the shoulder can reside within the lower portion.

21. The safety chain assembly according to claim 20, wherein the latch member has a latched position and an unlatched position; the spring being compressed between the clevis hook and the washer such that the shoulder is biased against the latch member when the latch member is in the unlatched position and the shoulder is immediately adjacent to the upper portion and the bottom surface of the head is biased against the latch member when the latch member is in the latched position and the shoulder resides within the lower portion; wherein the spring can be compressed by exerting force against the end of the pin proximate the annular groove when the latch member is in the latched position such that the shoulder is displaced sufficiently from the lower portion to permit the latch member to be displaced so that the shoulder is adjacent to the upper portion of the attachment opening which has at least one dimension that is smaller than at least one dimension of the shoulder.

22. A method of attaching a latch member and an elongated load bearing device to a safety hook, the latch member having an attachment opening, the safety hook being a clevis hook having two pin receiving openings and the elongated load bearing device having a securing opening, the method comprising the steps of:
3) providing a spring pin assembly, the spring pin assembly including a spring, a washer, a retention member and a pin; the pin having an annular groove, a head and first and second ends; the annular groove being located proximate the first end and the head being located proximate the second end; and
4) securing the elongated load bearing device and the latch member being interconnected to the clevis hook by the spring pin assembly; wherein the pin passes through the attachment opening, the two pin receiving openings and the securing opening to secure the elongated load bearing device and the latch member to the clevis hook, and the retention member is secured within at least a portion of the annular groove to retain the washer and the spring on the pin.

23. The method of claim 22, wherein the elongated load bearing device is a chain having a plurality of links, the plurality of links including a first link, the securing opening being located in the first link, and wherein the step of securing includes securing the chain and the latch member to the clevis hook by the spring pin assembly; wherein the pin passes through the attachment opening, the two pin receiving openings and the securing opening to secure the chain and the latch member to the clevis hook.

24. The method of claim 22, wherein the retention member is selected from the group consisting of a spring washer and a snap ring and the step of securing includes securing the retention member within at least a portion of the annular groove to retain the washer and the spring on the pin.

25. The method of claim 22, wherein the attachment opening has an upper portion and a lower portion and the pin has a shoulder adjacent to a bottom surface of the head, the shoulder having a cross-sectional, two-dimensional, shape through a thickness of the shoulder perpendicular to a longitudinal axis of the pin and the lower portion of the attachment opening having a shape similar to, but slightly enlarged in comparison to, the cross-sectional shape of the shoulder such that the shoulder can reside within the lower portion; wherein the latch member has a latched position and an unlatched position; the spring being compressed between the clevis hook and the washer such that shoulder is biased against the latch member when the latch member is in the unlatched position and the shoulder in immediately adjacent to the upper portion and the bottom surface of the head is biased against the latch member when the latch member is in the latched position and the shoulder resides within the lower portion; wherein the spring can be compressed by exerting force against the end of the pin proximate the annular groove when the latch member is in the latched position such that the shoulder is displaced sufficiently from the lower portion to permit the latch member to be displaced so that the shoulder is adjacent to the upper portion of the attachment opening that has at least one dimension that is smaller than at least one dimension of the shoulder; wherein the method further comprises a step of placing the latch member in the latched position, including:
a) exerting a force on the end of the pin proximate the annular groove such that the spring is further compressed when the latch member is in the unlatched position and such that the latch member can be displaced from the unlatched position, in which the shoulder is immediately adjacent the upper portion of the attachment opening, to an intermediate position in which the shoulder is immediately adjacent the lower portion of the attachment opening;
b) exerting a force on the latch member to displace the latch member from the unlatched position, in which the shoulder is immediately adjacent the upper portion of the attachment opening, to an intermediate position in which the shoulder is immediately adjacent the lower portion of the attachment opening;
c) permitting the biasing force of the spring to displace the shoulder into the lower opening to secure the latch member in the latched position.

26. The method of claim 25, wherein the method further comprises a step of placing the latch member in the unlatched position including:
a) exerting a force on the end of the pin proximate the annular groove such that the spring is further compressed when the latch member is in the latched position and such that the latch member can be displaced from the latched position, in which the shoulder is immediately adjacent the upper portion of the attachment opening, to an intermediate position in which the shoulder is immediately adjacent the lower portion of the attachment opening;
b) exerting a force on the latch member to displace the latch member from the latched position to the unlatched position in which the shoulder is immediately adjacent the upper portion of the attachment opening.
